(19) United States
(12) Patent Application Publication
(10) Pub. No.: US 2026/0189446 A1
(43) Pub. Date: Jul. 2, 2026

(54) OTSM-BASED COMMUNICATION METHOD, COMMUNICATION SYSTEM, AND COMPUTING DEVICE FOR PERFORMING THE SAME

(71) Applicant: INDUSTRY ACADEMIC COOPERATION FOUNDATION OF YEUNGNAM UNIVERSITY, Gyeongsangbuk-do (KR)

(72) Inventors: KWONHUE CHOI, Daegu (KR); HYUNGSEOP SON, Daegu (KR); HYEONG WON LEE, Daegu (KR)

(21) Appl. No.: 19/206,236

(22) Filed: May 13, 2025

(30) Foreign Application Priority Data
Dec. 30, 2024 (KR) 10-2024-0201143

(51) Int. Cl. H04L 27/26

(52) U.S. Cl. CPC H04L 27/2614

(57) ABSTRACT

An orthogonal time sequency multiplexing (OTSM)-based communication method includes generating a plurality of candidate matrices in a delay-time domain by multiplying data in row units in a delay-sequency domain by a plurality of preset scrambled Walsh-Hadamard transform (S-WHT) matrices or generating a plurality of candidate matrices in a delay-time domain by scrambling the data in row units in the delay-sequency domain by using a plurality of preset scramble vectors and then multiplying the scrambled data by the S-WHT matrices, and generating a data matrix in the delay-time domain based on the plurality of candidate matrices.

### CROSS-REFERENCE TO RELATED APPLICATION AND CLAIM OF PRIORITY

This application claims the benefit under 35 USC § 119 of Korean Patent Application No. 10-2024-0201143, filed on Dec. 30, 2024, in the Korean Intellectual Property Office, the entire disclosure of which is incorporated herein by reference for all purposes.

### BACKGROUND

### 1. Technical Field

Embodiments of the present disclosure relate to orthogonal time sequency multiplexing (OTSM)-based communication technology.

### 2. DESCRIPTION OF RELATED ART

5G communication networks and future 6G communication networks require stability for high-speed mobility in applications such as communication with high-speed moving objects such as high-speed trains, aircraft, and drones, and communication between autonomous vehicles (vehicle-to-everything (V2X) communication). Accordingly, two-dimensional modulation technologies such as orthogonal time frequency space (OTFS) and orthogonal time sequency multiplexing (OTSM) that utilize diversity in the time-frequency domain to increase signal robustness have been proposed.

However, these modulation technologies face a high peak-to-average power ratio (PAPR), which is a major factor in reducing the efficiency of power amplifiers and increasing signal distortion and energy consumption. Since conventional techniques for lowering the PAPR have the problem of canceling out the diversity of a signal, a method that can maximize the diversity of the signal while having a low PAPR is required.

Examples of related art include Korean registered patent publication No. 10-0528427 (2005.11.15).

### SUMMARY

Embodiments of the present disclosure is to provide an OTSM-based communication method and communication system capable of implementing a low PAPR and a computing device for performing the same.

According to an embodiment of the present disclosure, there is provided a communication method which is an orthogonal time sequency multiplexing (OTSM)-based communication method performed on a computing device including one or more processors and a memory storing one or more programs executed by the one or more processors, the OTSM-based communication method including generating a plurality of candidate matrices in a delay-time domain by multiplying data in row units in a delay-sequency domain by a plurality of preset scrambled Walsh-Hadamard transform (S-WHT) matrices or generating a plurality of candidate matrices in a delay-time domain by scrambling the data in row units in the delay-sequency domain by using a plurality of preset scramble vectors and then multiplying the scrambled data by the S-WHT matrices, and generating a data matrix in the delay-time domain based on the plurality of candidate matrices.

The scrambled WHT (S-WHT) matrix may be generated by multiplying a scramble diagonal matrix by a WHT matrix generated according to a column size of the delay-sequency domain, and the scramble diagonal matrix may be a matrix obtained by converting a scramble vector consisting of −1 and 1 into a diagonal matrix.

The generating of the data matrix in the delay-time domain may include calculating a peak-to-average power ratio (PAPR) for each row of each candidate matrix, and selecting a row having the smallest PAPR value among rows of each candidate matrix and configuring the selected row as a corresponding row of a data matrix in the delay-time domain.

The OTSM-based communication method may further include embedding side information about an S-WHT matrix or a scramble vector that causes the PAPR for each row of the data matrix in the delay-time domain to be the smallest into the data matrix of the delay-time domain.

In the embedding, the side information may be embedded into each row of the data matrix in the delay-time domain through phase rotation.

The side information may be embedded by Equation below,

$${X}_{DT , E}^{( i , 1 )} = {e}^{j \frac{π}{2 C} ( {k}_{\text{?}}^{*} - 1 )} {X}_{DT}^{\text{?}} \qquad Equation$$

$$\text{?} \text{indicates text missing or illegible when filed}$$

where

$${X}_{DT , E}^{( \text{?} )} :$$

$$\text{?} \text{indicates text missing or illegible when filed}$$

i-th row of data matrix X_{DT} in delay-time domain into which side information is embedded,
C: number of S-WHT matrices or number of scramble vectors,

$$\frac{π}{2 C} ( {k}_{i}^{\text{?}} - 1 )$$

$$\text{?} \text{indicates text missing or illegible when filed}$$

side information coefficient for i-th row of data matrix X_{DT}, and
k*ᵢ: index of scramble vector having the smallest PAPR for i-th row.

The OTSM-based communication method may further include setting the plurality of scrambled WHT (S-WHT) matrices or the plurality of scramble vectors in advance, and the setting of the plurality of S-WHT matrices or the plurality of scramble vectors in advance may include searching for a combination of the scramble vectors that minimizes the peak-to-average power ratio (PAPR) of input data.

The searching for the combination of the scramble vectors may be performed only when a digital modulation scheme of the data is binary phase shift keying (BPSK).

According to another embodiment of the present disclosure, there is provided a communication system which is an orthogonal time sequency multiplexing (OTSM)-based communication system including a transmitting device and a receiving device, and the transmitting device generates a plurality of candidate matrices in a delay-time domain by multiplying data in row units of a delay-sequency domain by a plurality of preset scrambled Walsh-Hadamard transform (S-WHT) matrices or generates a plurality of candidate matrices in a delay-time domain by scrambling the data in row units in the delay-sequency domain by using a plurality of preset scramble vectors and then multiplying the scrambled data by the S-WHT matrices, and generates a data matrix in the delay-time domain based on the plurality of candidate matrices.

### BRIEF DESCRIPTION OF THE DRAWINGS

FIG. 1 is a diagram schematically showing a process of transmitting and receiving a signal in orthogonal time sequency multiplexing (OTSM).

FIG. 2 is a diagram schematically showing an OTSM communication system according to an embodiment of the present disclosure.

FIG. 3 is a diagram schematically showing a process of transmitting and receiving a signal in an OTSM communication system according to an embodiment of the present disclosure.

FIG. 4 is a diagram schematically showing a process of generating a data matrix in a delay-time domain by a transmitting device in the OTSM communication system according to an embodiment of the present disclosure.

FIG. 5 is a diagram illustrating an algorithm for finding a combination of scramble vectors that creates a minimum PAPR in an embodiment of the present disclosure.

FIG. 6 is a graph comparing the PAPR when using an S-WHT matrix according to an embodiment of the present disclosure with the PAPR of another communication method.

FIG. 7 is a graph comparing the BER performance when using an S-WHT matrix according to an embodiment of the present disclosure with the BER performance of another communication method.

FIG. 8 is a flowchart for describing an OTSM-based communication method according to an embodiment of the present disclosure.

FIG. 9 is a block diagram for illustratively describing a computing environment including a computing device suitable for use in exemplary embodiments.

### DETAILED DESCRIPTION

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of the present disclosure, when it is determined that a detailed description of related known technologies may unnecessarily obscure the subject matter of the present disclosure, a detailed description thereof will be omitted. Additionally, terms to be described later are terms defined in consideration of functions in the present disclosure, which may vary according to the intention or custom of users or workers. Therefore, the definition should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

In addition, the terms “first”, “second”, etc. may be used to describe various components, but the components should not be limited by the terms. The terms may be used to distinguish one component from another. For example, a first component may be referred to as a second component without departing from the scope of the present disclosure, and similarly, a second component may also be referred to as a first component.

In the disclosed embodiment, a new method that maximizes diversity while effectively reducing a peak-to-average power ratio (PAPR) by utilizing the Walsh-Hadamard transform (WHT) characteristics of orthogonal time sequency multiplexing (OTSM) is proposed. That is, a low PAPR OTSM technique that selectively uses a scrambled-WHT (S-WHT) matrix to reduce the PAPR and maximize diversity while maintaining the orthogonality of the WHT.

More specifically, a diagonal matrix for multiplying each column of a WHT matrix by 1 or −1 may be generated, and the S-WHT matrix may be generated by multiplying the original WHT matrix by the diagonal matrix. By selecting a S-WHT matrix that minimizes a PAPR among the various S-WHT matrices generated in this way and performing data transformation on the matrix, the PAPR of the entire system can be lowered. Since column components of the S-WHT matrix generated in this way still maintains orthogonality, the effect of generating a large PAPR during a transformation process is reduced while ensuring the orthogonality of the data, thereby capable of generating a low PAPR signal.

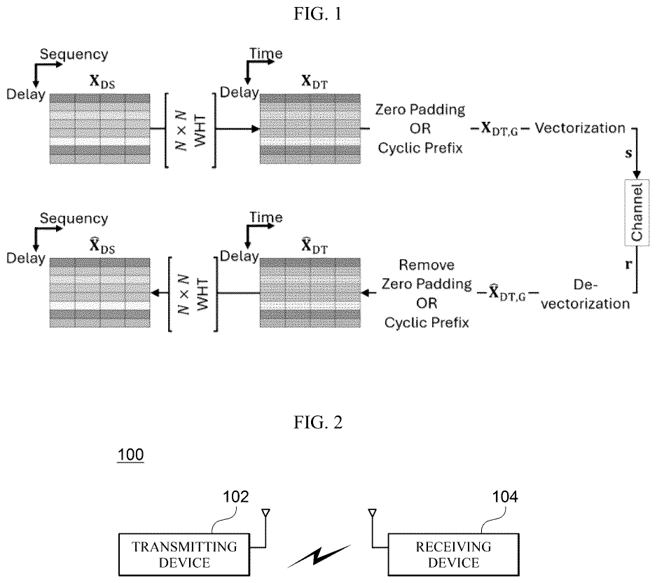

FIG. 1 is a diagram schematically showing a process of transmitting and receiving a signal in orthogonal time sequency multiplexing (OTSM).

Referring to FIG. 1, the OTSM is a modulation scheme that places data symbols in a delay-sequency domain and then converts the data symbols into data symbols in a delay-time domain using the Walsh-Hadamard transform (WHT). A data matrix in the delay-sequency domain (DS domain) may be expressed as X_{DS}∈ [symbol] M×N. Here, M and N represent the number of grids in a delay axis and a sequence axis, respectively. The data matrix X_{DS} may be converted into a matrix in a delay-time domain (DT domain) X_{DT}∈ [symbol] M×N by applying the Walsh-Hadamard transform (WHT) to the sequence axis as shown in the following Equation 1.

$${X}_{DT} = {X}_{DS} \cdot {W}_{N} \qquad Equation 1$$

W_{N}: normalized WHT matrix of size N×N
X_{DT,G}∈ [symbol] ^{(M+Z)×N} may be generated by applying zero padding (ZP) to the data matrix X_{DT} as shown in Equation 2 below or by applying cyclic prefix (CP) as shown in Equation 3 below.

$${X}_{DT , G} = [ \begin{matrix}{I}_{M \times M} \\ {0}_{Z \times M}\end{matrix} ] \cdot {X}_{DT} \qquad Equation 2$$

$${X}_{DT , G} = [ \begin{matrix}{0}_{Z \times ( M - Z )} {I}_{Z \times Z} \\ {I}_{M \times M}\end{matrix} ] \cdot {X}_{D T} \qquad Equation 3$$

Z: length of zero padding
I_{M×M}: M×M identity matrix
0_{Z×M}: Z×M zero matrix

Next, a sample signal S∈ [symbol] ^{(M+Z)×1} in the time domain may be generated by vectorizing the data matrix X_{DT,G} in column units as shown in Equation 4 below. After that, the sample signal S is subjected to pulse shaping and then subjected to digital-to-analog conversion (DAC) to be transmitted to a wireless communication channel.

$$s = vec ( {X}_{DT , S} ) \qquad Equation 4$$

In addition, a receiving process goes through a reverse process of the transmitting process. Since the transmitting and receiving process for the OTSM is a known technology, a detailed description thereof will be omitted.

Meanwhile, when the Walsh-Hadamard transform (WHT) is performed in the OTSM, Walsh-Hadamard transform (WHT) is applied row-wise to the sequency axis of the delay-sequency domain. In this case, a signal has a high peak-to-average power ratio (PAPR) due to the WHT.

Accordingly, in the disclosed embodiment, in order to ensure that the signal has a low, a new WHT that lowers the PAPR by multiplying the WHT by a diagonal matrix of the binary scramble may be found and utilized. Here, the new WHT obtained by multiplying the WHT by the diagonal matrix of binary scramble may be referred to as scrambled WHT (S-WHT). That is, the S-WHT that minimizes the PAPR of the signal may be found and applied to the sequency axis in the delay-sequency domain.

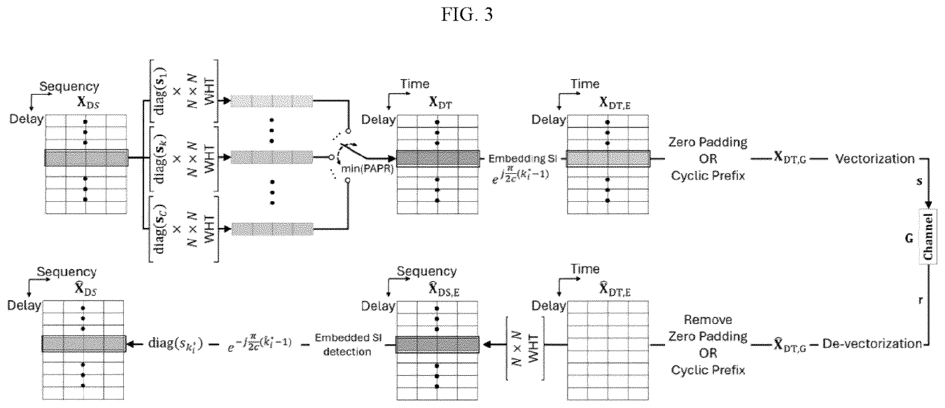

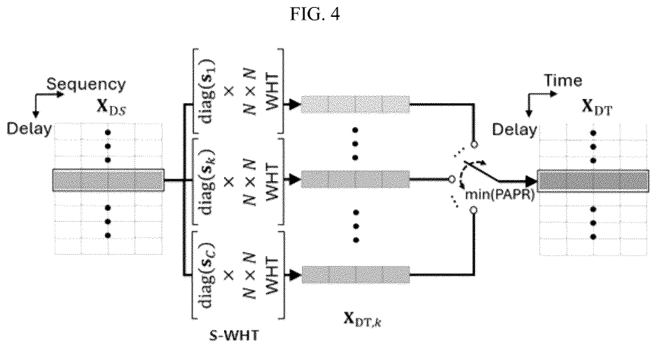

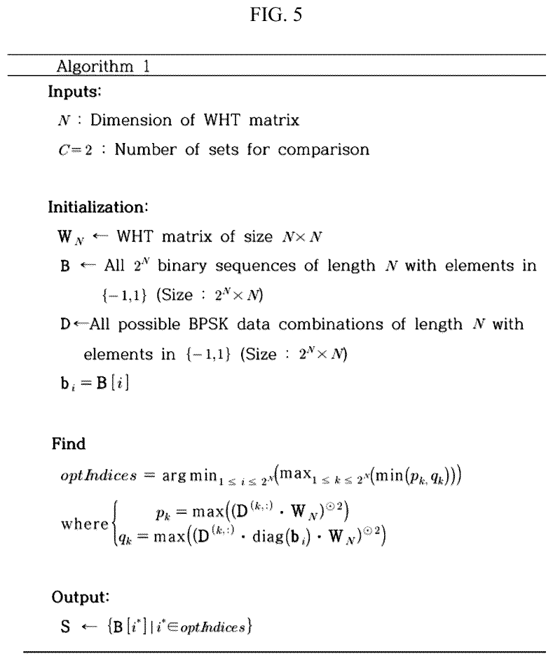

FIG. 2 is a diagram showing an OTSM communication system according to an embodiment of the present disclosure, FIG. 3 is a diagram schematically showing a signal transmission and receiving process in the OTSM communication system according to an embodiment of the present disclosure, and FIG. 4 is a diagram separately showing a process in which a transmitting device generates a data matrix in the delay-time domain in the OTSM communication system according to an embodiment of the present disclosure.

Referring to FIGS. 2 to 4, an OTSM communication system 100 may include a transmitting device 102 and a receiving device 104. The transmitting device 102 and the receiving device 104 are communicatively connected to each other through a communication network.

The transmitting device 102 may receive data bits, digitally modulate the data bits, and then map the modulated data symbols to the delay-sequency domain. The transmitting device 102 may multiply each of data in row units in the delay-sequence domain by the S-WHT to generate a plurality of candidate matrices in the delay-time domain.

Specifically, an S-WHT matrix W_{N,k} may be defined as a matrix obtained by converting a 1×N-sized scramble vector Sₖ consisting of −1 and 1 into a diagonal matrix (hereinafter, referred to as a scramble diagonal matrix) and multiplying the diagonal matrix by the original WHT matrix W_{N}. This may be expressed by Equation 5.

$${W}_{N , k} = diag ( {s}_{k} ) \cdot {W}_{N} \qquad Equation 5$$

diag(Sₖ): scrambled diagonal matrix

Here, k=1, 2, . . . , C, and C is the number of S-WHT matrices. Accordingly, a plurality of S-WHT matrices (i.e., C S-WHT matrices) may be generated. In an embodiment, the scramble vector may include a case where the values thereof consist only of ones. In this case, the S-WHT matrix becomes the same as the original WHT matrix. That is, the S-WHT matrix W_{N,k} may also include the original WHT matrix. In this case, s1=[1, 1, 1, 1] may be used.

Meanwhile, the transmitting device 102 may multiply data in row units in the delay-sequency domain by a plurality of scramble vectors in element-wise and then multiply the multiplication result by the WHT to generate a plurality of candidate matrices in the delay-time domain. That is, it is also possible to scramble data in row units in the delay-sequence domain using a scramble vector and then multiply the data scrambling result by the WHT to generate multiple candidate matrices in the delay-time domain.

The transmitting device 102 may multiply the data in row units of the data matrix X_{DS} in the delay-sequency domain by the S-WHT matrix W_{N,k} to generate C X_{DT,k} candidate matrices in the delay-time domain as in Equation 6. In this case, C candidate matrices X_{DT,k} are generated for the data matrix X_{DS}.

$${X}_{DT , k} = {X}_{DS} \cdot {W}_{N , k} \qquad Equation 6$$

The transmitting device 102 may calculate the PAPR for an i-th row of each candidate matrix X_{DT,k} by Equation 7 below.

$$PAPR ( {X}_{DT , k}^{( i , : )} ) = \frac{{max}_{q} {\vert {X}_{DT , k}^{( i , q )} \vert}^{2}}{\frac{1}{N} {\sum }_{j = 1}^{N} {\vert {X}_{DT , k}^{( i , j )} \vert}^{2}} \qquad Equation 7$$

Here, i=1, 2, . . . , M,

$${X}_{DT , k}^{( i , : )}$$

is the i-th row of X_{DT,k},

$${X}_{DT , k}^{( i , j )}$$

is an element corresponding to the i-th row and j-th column of X_{DT,k}.

The transmitting device 102 may find an index k of the scramble vector having the smallest PAPR among the i-th rows of the candidate matrices X_{DT,k}. This may be expressed by Equation 8 below.

$${k}_{i}^{*} = arg {min}_{k} ( PAPR ( {X}_{DT , k}^{( i , : )} ) ) \qquad Equation 8$$

The transmitting device 102 may select the row having the smallest PAPR value among the i-th rows of the candidate matrices X_{DT,k} and configure the selected row as the i-th row of the data matrix X_{DT} in the delay-time domain. This may be expressed by Equation 9 below.

$${X}_{DT}^{( i , : )} = {X}_{DT , {k}_{i}^{*}}^{( i , : )} \qquad Equation 9$$

The transmitting device 102 may select the rows having the smallest PAPR for all rows of the candidate matrices X_{DT,k} and configure the data matrix in the delay-time domain X_{DT} as Equation 10 below.

$${X}_{DT} = ( \begin{matrix}{X}_{DT , {k}_{1}^{*}}^{( 1 , : )} \\ {X}_{DT , {k}_{2}^{*}}^{( 2 , : )} \\ ⋮ \\ {X}_{DT , {k}_{M}^{*}}^{( M , : )}\end{matrix} ) \qquad Equation 10$$

The transmitting device 102 may embed side information about which S-WHT matrix that causes the PAPR for each row of the data matrix X_{DT} to be the smallest among the S-WHT matrices into the data matrix. The side information may include the number of S-WHT matrices and the index of the scramble vector having the smallest PAPR for each row. In this case, the transmitting device 102 may embed the side information into a data frame and transmit the data frame without additional transmission.

The transmitting device 102 may embed the side information into each row of the data matrix X_{DT} through phase rotation. This may be expressed by Equation 11 below.

$${X}_{DT , E}^{( i , : )} = {e}^{j \frac{π}{2 C} ( {k}_{\text{?}}^{\text{?}} - 1 )} {X}_{DT}^{( \text{?} )} \qquad Equation 11$$

$$\text{?} \text{indicates text missing or illegible when filed}$$

$${X}_{DT , E}^{( i , : )} :$$

i-th row of data matrix into which side information is embedded
C: number of S-WHT matrices

$$\frac{π}{2 C} ( {k}_{i}^{*} - 1 ) ;$$

side information coefficient for i-th row of X_{DT}

$${k}_{i}^{*} :$$

index of scramble vector having the smallest PAPR for i-th row

This takes advantage of the constellation invariant property that the scramble vector

$${s}_{{k}_{i}^{*}}$$

has because the scramble vector

$${s}_{{k}_{i}^{*}}$$

has the smallest PAPR value for the i-th row is a binary vector consisting of 1 and −1. Here, the transmitting device 102 may divide

$$\frac{π}{2}$$

by C to distinguish C S-WHTs and apply a different phase rotation according to each S-WHT matrix. That is, the S-WHT matrix has different constellations depending on the degree of phase rotation, and the receiving device 104 may detect the different constellation and know the S-WHT matrix used in the transmitting device 102 (i.e., the S-WHT matrix that causes the PAPR to be the minimum value).

The transmitting device 102 may apply zero padding (ZP) or cyclic prefix (CP) to the data matrix X_{DT,E} into which the side information is embedded and then vectorize the data matrix X_{DT,E} in column units to generate a signal s(t) in the time domain. The transmitting device 102 may transmit the signal s(t) to the receiving device 104.

The receiving device 104 may receive the signal s(t) transmitted by the transmitting device 102. The receiving device 104 may generate a data matrix \hat{X}_{DT,E}∈ [symbol] ^{M×N}, in the delay-time domain based on the received signal s(t). The receiving device 104 may generate a data matrix in the delay-time domain through de-vectorization and zero padding or cyclic prefix removal processes for the received signal s(t).

The receiving device 104 may obtain a data matrix \hat{X}_{DT,E}∈ [symbol] ^{M×N} delay-sequency domain through the WHT for the data matrix \hat{X}_{DT,E} in the delay-time domain. The receiving device 104 may detect the S-WHT matrix used in the transmitting device 102) (i.e., the S-WHT matrix that causes the PAPR to be the minimum value based on the embedded side information of each row in the data matrix \hat{X}_{DS,E} in the delay-sequency domain. That is, the receiving device 104 may estimate

$${\hat{k}}_{i}^{*}$$

(i.e., the index of the scramble vector having the smallest PAPR value for the i-th row based on the side information coefficient of each row in the data matrix \hat{X}_{DS,E}.

Specifically, since the side information is embedded through phase rotation in the transmitting device 102, the receiving device 104 may detect

$$\frac{π}{2 C} ( {k}_{i}^{*} - 1 ) ,$$

which is a side information coefficient, in each row of the data matrix \hat{X}_{DS,E}. Here, there may be two methods for detecting

$$\frac{π}{2 C} ( {k}_{i}^{*} - 1 ) .$$

One of the two methods is to use the maximum likelihood technique, and the other thereof is to use the minimum distance-based technique.

First, the maximum likelihood technique is described.

A digital modulation symbol that has been subjected to phase rotation by

$$\frac{π}{2 C} ( k - 1 ) is {ℚ}_{rot , k} = \{ q \cdot {e}^{j \frac{π}{2 C} ( k - 1 )} \vert q ∈ ℚ \text{?} \} .$$

$$\text{?} \text{indicates text missing or illegible when filed}$$

The receiving device 104 may calculate the Euclidean distance between the data matrix \hat{X}_{DS,E} and the digital modulation symbol set [symbol] _{rot,k} as in Equation 12 below.

$$d ( {\hat{X}}_{DS , E}^{( i , n )} , {\tilde{q}}_{k} ) = {\vert {\hat{X}}_{DS , E}^{( i , n )} - {\tilde{q}}_{k} \vert}^{2}$$

$${\hat{X}}_{DS , E}^{( i , n )} :$$

element of the i-th row and n-th column of the data matrix \hat{X}_{DS,E}
\tilde{q}ₖ: digital modulation symbol that has been subjected to phase rotation corresponding to index k of scramble vector

Here, the symbol \tilde{q}ₖ satisfies \tilde{q}k∈ [symbol] _{rot,k}.

The receiving device 104 may calculate the likelihood function for the digital modulation symbol \tilde{q}ₖ by considering the Euclidean distance and noise power between the data matrix \hat{X}_{DS,E} and the digital modulation symbol set [symbol] _{rot,k} as in Equation 13 below.

$$p ( {\hat{X}}_{DS , E}^{( i , n )} \vert {\tilde{q}}_{k} ) = \frac{1}{\sqrt{2 {πσ}^{2}}} {e}^{( \frac{- d ( {\hat{X}}_{DS , E}^{( i , n )} , {\tilde{q}}_{k} )}{2 {σ}^{2}} )}$$

Here, σ² is Additive White Gaussian Noise (AWGN).

The receiving device 104 may calculate the Euclidean distance-based likelihood function between

$${\hat{X}}_{DS , E}^{( i , n )}$$

and the digital modulation symbol set [symbol] _{rot,k} as in Equation 14 below. That is, the likelihood functions for each digital modulation symbol \tilde{q}ₖ calculated through Equation 14 may be added.

$${P}^{( n , k )} = \text{?} p ( {\hat{X}}_{DS , E}^{( i , n )} \vert {\tilde{q}}_{k} ) QUERY$$

$$\text{?} \text{indicates text missing or illegible when filed}$$

Here, P^{(n,k)} is the distance-based probability between

$${\hat{X}}_{DS , E}^{( i , n )}$$

and the digital modulation symbol set [symbol] _{rot,k}, and represents the possibility that a signal will occur in the digital modulation symbol set based on the calculated distance. The product probability of all columns n for the [symbol] _{rot,k} may be calculated as in Equation 21. That is, all columns n of an i-th row of \hat{X}_{DS,E} may be multiplied by the likelihood function calculated in Equation 20 to calculate the product probability as in Equation 15.

$${p}^{( k )} = {{\prod }_{n = 1}}^{N} {P}^{( n , k )} \qquad Equation 15$$

Here, the receiving device 104 may estimate the index of the scramble vector of the i-th row by selecting a k value having the maximum likelihood as in Equation 16 below.

$${\hat{k}}_{i}^{*} = arg {max}_{k} {p}^{( k )}$$

The receiving device 104 may calculate an index

$${\hat{k}}_{i}^{*}$$

of the estimated scramble vector for each row of the data matrix and through this calculation, a final delay-sequency data matrix may be calculated as in Equation 17 below.

$${\hat{X}}_{DS} = [ \begin{matrix}{e}^{- j \frac{π}{2 C} ( {\hat{k}}_{1}^{*} - 1 )} {\hat{X}}_{DS , E}^{\text{?}} diag ( {\hat{s}}_{{k}_{1}^{*}} ) \\ {e}^{- j \frac{π}{2 C} ( {\hat{k}}_{2}^{*} - 1 )} {\hat{X}}_{DS , E}^{\text{?}} \text{?} diag ( {\hat{s}}_{{k}_{2}^{*}} ) \\ ⋮ \\ {e}^{- j \frac{π}{2 C} ( {\hat{k}}_{M}^{*} - 1 )} {\hat{X}}_{DS , E}^{\text{?}} \text{?} diag ( {\hat{s}}_{{k}_{M}^{*}} )\end{matrix} ] \qquad Equation 17$$

$$\text{?} \text{indicates text missing or illegible when filed}$$

Next, the minimum distance-based technique is described. The minimum distance-based technique is a method that has lower complexity than the maximum likelihood technique.

The receiving device 104 may calculate the minimum distance between the element of the i-th row and n-th column of the data matrix \hat{X}_{DS,E} and the digital modulation symbol that has been subjected to phase rotation. This may be expressed as in Equation 18.

$${D}^{( n , k )} = {min}_{{\tilde{q}}_{k} ∈ Q \text{?}} d ( {\hat{X}}_{DS , E}^{( i , n )} , {\tilde{q}}_{k} ) \qquad Equation 18$$

$$\text{?} \text{indicates text missing or illegible when filed}$$

Next, the receiving device 104 may calculate the total distance for the index k of the scramble vector by summing the minimum distances calculated for all column elements of the i-th row of the data matrix \hat{X}_{DS,E}, as in Equation 19 below.

$${d}^{( k )} = {{\sum }_{n = 1}}^{N} {D}^{( n , k )} \qquad Equation 19$$

Next, the receiving device 104 may estimate the index of the scramble vector of the i-th row by selecting the k value having the smallest total distance for the index k of the scramble vector as in Equation 20.

$${\hat{k}}_{i}^{*} = arg min {x}_{k} {d}^{( k )} \qquad Equation 20$$

The receiving device 104 may calculate an index

$${\hat{k}}_{i}^{*}$$

of the estimated scramble vector for each row of the data matrix \hat{X}_{DS,E} and may calculate a final delay-sequency data matrix through the calculation of the index

$${\hat{k}}_{i}^{*}$$

### as in Equation 17.

Meanwhile, the transmitting device 102 may set the S-WHT set (i.e., W_{N,k}) that may minimize the PAPR before performing communication with the receiving device 104. That is, since actual data is randomly generated, a fixed S-WHT set (i.e., W_{N,k}) that may minimize the PAPR for all data should be searched for in advance. Here, since the WHT is a preset value, searching for the fixed S-WHT set that may minimize the PAPR for all data becomes a matter of searching for a scramble vector Sₖ.

In an embodiment, when the transmitting device 102 searches for the scramble vector Sₖ, a digital modulation method of data may be limited to binary phase shift keying (BPSK). For example, if the digital modulation scheme is quadrature phase shift keying (QPSK) (i.e., 4-QAM), a data signal vector is expressed as d=[d₀, d₁, . . . , d_{N-1}] and each component satisfies dₖ∈{1+1j,1−1j,−1+1j,−1−2j}. In this case, if the WHT transformation is performed on the data signal vector d, it is y=d·W_{N}, and an i-th component yᵢ of y may be expressed as in Equation 21 below.

$${y}_{i} = {{\sum }_{k = 0}}^{N - 1} {d}_{k} \cdot {W}_{N} [ k , i ] \qquad Equation 21$$

Here, since d, which maximizes the PAPR value of y, is the BPSK multiplied by a certain complex constant, when searching for a scramble vector that lowers the PAPR, the digital modulation scheme may be limited to the BPSK. Therefore, the transmitting device 102 may search for a combination of scramble vectors that minimizes the PAPR for data combination (i.e., 2^{N}) of BPSKs.

The transmitting device 102 may generate a candidate matrix X_{DT,k} by multiplying each BPSK data by the S-WHT matrix W_{N,k} by all combinations of scramble vectors. Here, the transmitting device 102 may extract the maximum peak for each of i-th rows of the candidate matrices X_{DT,k}. The transmitting device 102 may search for the scramble vector that generates the smallest peak among the extracted maximum peaks. The transmitting device 102 may perform such an operation for all k-th rows.

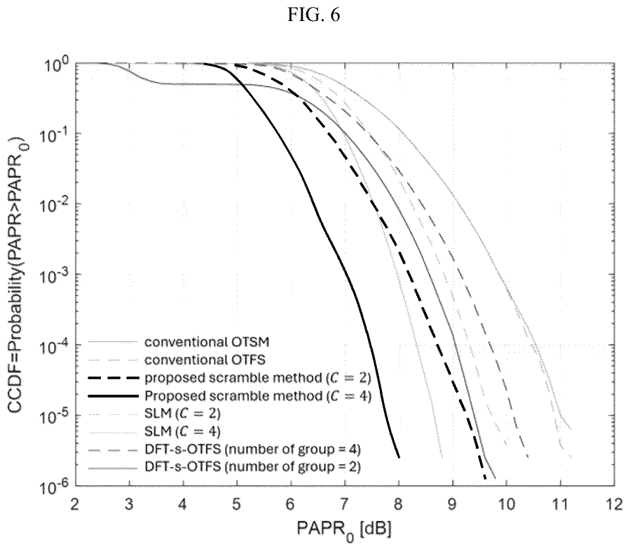

In this way, the transmitting device 102 may extract the scramble vectors that create the minimum PAPR for each BPSK data and create a combination of scramble vectors for generating the S-WHT. For example, a method of finding a combination of s₁ and s₂ that creates) the minimum PAPR when C=2 may be expressed as Algorithm 1 illustrated in FIG. 5.

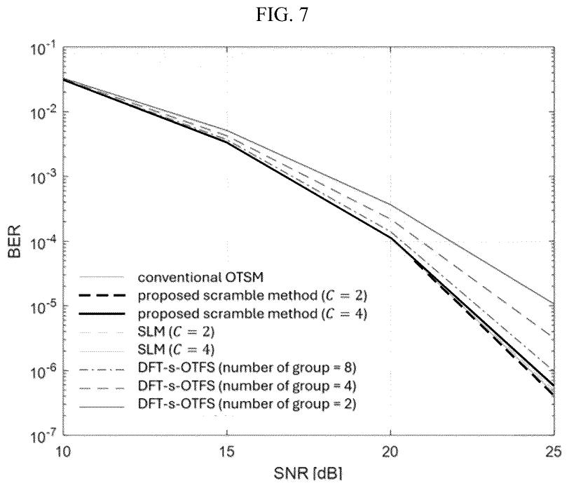

FIG. 6 is a graph comparing the PAPR when using an S-WHT matrix according to an embodiment of the present disclosure with the PAPR of another communication method. Here, the PAPR is shown when data is QPSK data, M=129, and N=16. Referring to FIG. 6, it may be seen that the PAPR of the communication method according to the embodiment of the present disclosure (proposed scramble method) is lower than that of other communication methods (conventional OTSM, conventional OTFS, SLM, and DFT-s-OTFS).

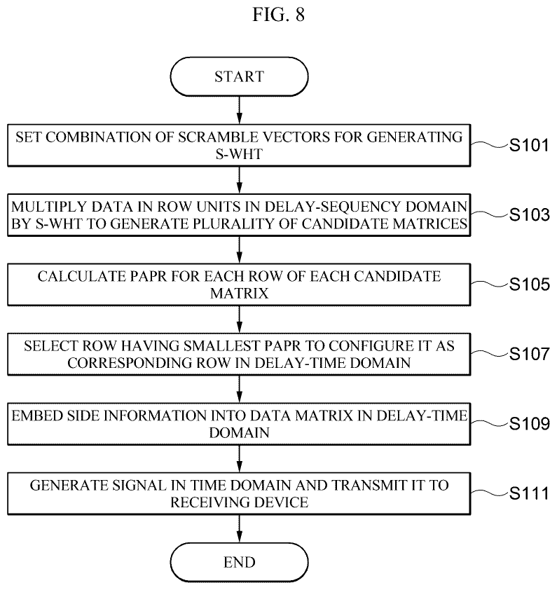

FIG. 7 is a graph comparing the Bit Error Rate (BER) performance when using an S-WHT matrix according to an embodiment of the present disclosure with the BER performance of another communication method. Here, the BER performance according to the signal to noise ratio (SNR) is shown when data is QPSK data, M=129, and N=16. Referring to FIG. 7, it may be seen that the BER performance of the method according to the embodiment of the present disclosure (the proposed scramble method) is almost the same as that of other communication methods (conventional OTSM, conventional OTFS, SLM, and DFT-s-OTFS).

According to the disclosed embodiment, the PAPR of the signal may be reduced by applying the S-WHT matrix while maintaining the robustness of OTSM to multipath fading and Doppler shift. In particular, the advantages of OTSM in high-speed channels may be maintained without degrading the performance and without changing the characteristics of the OTSM signal itself.

FIG. 8 is a flowchart for describing an OTSM-based communication method according to an embodiment of the present disclosure. In the illustrated flow chart, the method is described by being divided into a plurality of steps, but at least some of the steps may be performed in a different order, performed by being combined with other steps, omitted, performed by being divided into sub-steps, or performed by being added with one or more steps (not illustrated).

Referring to FIG. 8, the transmitting device 102 may extract scramble vectors that create a minimum PAPR for each BPSK data to set a combination of scramble vectors for generating S-WHT (S 101).

Next, the transmitting device 102 may multiply data in row units in the delay-sequency domain by the S-WHT matrix according to the combination of the set scramble vectors to generate a plurality of candidate matrices in the delay-time domain (S 103).

Next, the transmitting device 102 may calculate the peak-to-average power ratio (PAPR) for each row of each candidate matrix (S 105), and select a row having the smallest PAPR among the rows of each candidate matrix to configure the row as the corresponding row of the data matrix of the delay-time domain (S 107).

Next, the transmitting device 102 may embed side information for the S-WHT matrix that causes the PAPR for each row of the data matrix in the delay-time domain to be the smallest into the data matrix in the delay-time domain (S 109).

Next, the transmitting device 102 may apply zero padding (ZP) or cyclic prefix (CP) to the data matrix into which the side information is embedded, and then vectorize the data matrix in column units to generate a signal s(t) in the time domain and transmit the signal s(t) to the receiving device 104 (S 111).

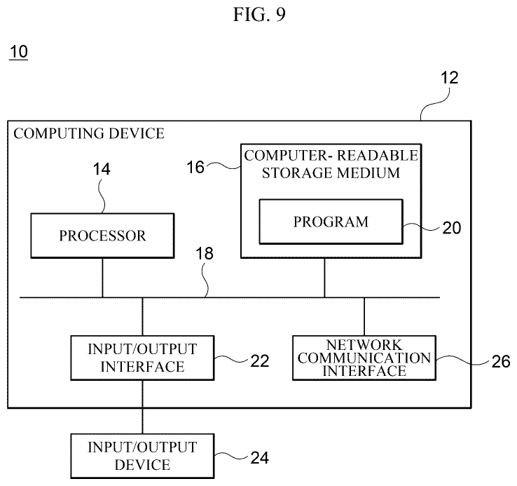

FIG. 9 is a block diagram for describing a computing environment 10 including a computing device suitable for use in exemplary embodiments. In the illustrated embodiment, respective components may have different functions and capabilities other than those described below, and may include additional components in addition to those described below.

The illustrated computing environment 10 includes a computing device 12. In an embodiment, the computing device 12 may be a communication device for OTSM communication. The computing device 12 may be a communication device for causing the OTSM transmission signal to have an overall low PAPR signal. That is, the computing device 12 may be the transmitting device 102. In addition, the computing device 12 may be the receiving device 104.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured so that the computer-executable instruction or program code, program data, and/or other suitable forms of information are stored. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to an embodiment, by applying the S-WHT matrix, it is possible to reduce the PAPR of the signal while maintaining the robustness of OTSM against multi-path fading and Doppler shift. In particular, it is possible to maintain the advantages of OTSM in high-speed channels without degrading performance and without changing the characteristics of the OTSM signal itself.

Although representative embodiments of the present disclosure have been described in detail, a person skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents to the claims.

What is claimed is:

1. An orthogonal time sequency multiplexing (OTSM)-based communication method performed on a computing device including one or more processors and a memory storing one or more programs executed by the one or more processors, the OTSM-based communication method comprising:
generating a plurality of candidate matrices in a delay-time domain by multiplying data in row units in a delay-sequency domain by a plurality of preset scrambled Walsh-Hadamard transform (S-WHT) matrices or generating a plurality of candidate matrices in a delay-time domain by scrambling the data in row units in the delay-sequency domain by using a plurality of preset scramble vectors and then multiplying the scrambled data by the S-WHT matrices; and
generating a data matrix in the delay-time domain based on the plurality of candidate matrices.

2. The OTSM-based communication method of claim 1,
wherein the scrambled WHT (S-WHT) matrix is generated by multiplying a scramble diagonal matrix by a WHT matrix generated according to a column size of the delay-sequency domain, and
the scramble diagonal matrix may be a matrix obtained by converting a scramble vector consisting of −1 and 1 into a diagonal matrix.

3. The OTSM-based communication method of claim 2,
wherein the generating of the data matrix in the delay-time domain includes:
calculating a peak-to-average power ratio (PAPR) for each row of each candidate matrix; and
selecting a row having the smallest PAPR value among rows of each candidate matrix and configuring the selected row as a corresponding row of a data matrix in the delay-time domain.

4. The OTSM-based communication method of claim 3, further comprising:
embedding side information about an S-WHT matrix or a scramble vector that causes the PAPR for each row of the data matrix in the delay-time domain to be the smallest into the data matrix in the delay-time domain.

5. The OTSM-based communication method of claim 4,
wherein, in the embedding, the side information is embedded into each row of the data matrix in the delay-time domain through phase rotation.

6. The OTSM-based communication method of claim 5,
wherein the side information is embedded by Equation below,
$${X}_{DT , E}^{\text{?}} = {e}^{j \frac{π}{2 C} ( {k}_{i}^{*} - 1 )} {X}_{DT}^{\text{?}} \qquad Equation$$
$$\text{?} \text{indicates text missing or illegible when filed}$$
where
$${X}_{DT , E}^{\text{?}} :$$
$$\text{?} \text{indicates text missing or illegible when filed}$$
i-th row of data matrix X_{DT} in delay-time domain into which side information is embedded,
C: number of S-WHT matrices or number of scramble vectors,
$$\frac{π}{2 C} ( {k}_{i}^{*} - 1 ) :$$
side information coefficient for i-th row of data matrix X_{DT}, and
$${k}_{i}^{*} :$$
index of scramble vector having the smallest PAPR for i-th row.

7. The OTSM-based communication method of claim 2, further comprising:
setting the plurality of scrambled WHT (S-WHT) matrices or the plurality of scramble vectors in advance,
wherein the setting of the plurality of S-WHT matrices or the plurality of scramble vectors in advance includes searching for a combination of the scramble vectors that minimizes the peak-to-average power ratio (PAPR) of input data.

8. The OTSM-based communication method of claim 7,
wherein the searching for the combination of the scramble vectors is performed only when a digital modulation scheme of the data is binary phase shift keying (BPSK).

9. An orthogonal time sequency multiplexing (OTSM)-based communication system, comprising:
a transmitting device; and
a receiving device,
wherein the transmitting device generates a plurality of candidate matrices in a delay-time domain by multiplying data in row units of a delay-sequency domain by a plurality of preset scrambled Walsh-Hadamard transform (S-WHT) matrices or generates a plurality of candidate matrices in a delay-time domain by scrambling the data in row units in the delay-sequency domain by using a plurality of preset scramble vectors and then multiplying the scrambled data by the S-WHT matrices, and generates a data matrix in the delay-time domain based on the plurality of candidate matrices.

10. The OTSM-based communication system of claim 9,
wherein the scrambled WHT (S-WHT) matrix is generated by multiplying a scramble diagonal matrix by a WHT matrix generated according to a column size of the delay-sequency domain, and
the scramble diagonal matrix may be a matrix obtained by converting a scramble vector consisting of −1 and 1 into a diagonal matrix.

11. The OTSM-based communication system of claim 10,
wherein the transmitting device is configured to embed side information about an S-WHT matrix or a scramble vector that causes the PAPR for each row of the data matrix in the delay-time domain to be the smallest into the data matrix in the delay-time domain, and
the receiving device is configured to receive a signal into which the side information from the transmitting device is embedded, calculate a data matrix in a delay-sequency domain based on the received signal, and detect an S-WHT matrix used by the transmitting device based on side information embedded into each row of the data matrix in the delay-sequency domain.

12. The OTSM-based communication system of claim 11,
wherein the receiving device is configured to estimate an index of a scramble vector that causes the PAPR for the row to be the smallest value based on a Euclidean distance between the data matrix in the delay-sequency domain and a digital modulation symbol subjected to phase rotation corresponding to an index of the scramble vector.

13. The OTSM-based communication system of claim 12,
wherein the receiving device is configured to calculate a minimum distance between elements of each row and each column of the data matrix of the delay-sequency domain and the digital modulation symbol subjected to phase rotation, calculates a total distance for each index of the scramble vector by summing the calculated minimum distances for all column elements of a specific row of the data matrix in the delay-sequency domain, and estimate an index that has a small total distance for each index of the scramble vector as an index of the scramble vector that causes the PAPR to be the smallest value.
